(19) United States
(12) Patent Application Publication
(10) Pub. No.: US 2023/0371744 A1
(43) Pub. Date: Nov. 23, 2023

(54) PELLET OVEN WITH NEGATIVE PRESSURE COMBUSTION

(71) Applicant: JINHUA XINAN ELECTRIC CO., LTD., Jinhhua (CN)

(72) Inventors: Binglu SONG, Jinhhua (CN); Yanrong HUANG, Jinhhua (CN)

(21) Appl. No.: 18/319,285

(22) Filed: May 17, 2023

(30) Foreign Application Priority Data
May 18, 2022 (CN) 202210537316.9

(51) Int. Cl. A47J 37/07; A47J 37/01

(52) U.S. Cl. CPC A47J 37/0704; A47J 37/01; A47J 37/0786

(57) ABSTRACT

The present invention relates to a pellet oven with negative pressure combustion, comprising: a grill body, and a combustion assembly, an iron plate, a grilling grate, an air duct assembly, and a fan installed within said grill body. Said grilling grate is installed above-said iron plate for a distance. Said combustion assembly is mounted in the lower left of said iron plate. Said air duct assembly is located at the right of said iron plate, and extends below said iron plate to a position under said grilling grate. Said air duct assembly has air inlet ports and air outlets at its lower and upper ends respectively. Said fan is installed inside said air duct assembly. Through these, the present invention realizes simultaneous plate-cooking and grill roasting, making the whole cooking process easier and more efficient.

### FIELD OF THE DISCLOSURE

The present invention relates to a pellet oven with negative pressure combustion.

### BACKGROUND

A grill oven is a tool used to make food, which can be used for making barbecue food, such as, grilled meat, roasted vegetables, etc. Depending on the heating sources, grill ovens can be divided into wood pellet ovens, gas grill ovens and electric grill ovens, etc. A wood pellet oven uses the heat generated by burning wood pellets to cook food. There are two ways to cook food using grill ovens, namely, plate cooking and grill roasting. The two methods have their own characteristics and their differences in taste and flavor. The biggest difference between the two is that grill roasting uses hot air to slowly roast the food, giving it the smoky smell of burned wood, while plate cooking refers to the faster and more efficient baking of food at high temperatures by contacting the surface of the iron plate. As such, both methods are popular with a large user group. However, none of the existing grill ovens can be used for simultaneous plate cooking and grill roasting, leaving room for improvement in terms of cooking efficiency and operation convenience.

### SUMMARY OF THE DISCLOSURE

The present invention aims to solve technical issues regarding a pellet oven with negative pressure combustion that can be used for simultaneous plate-cooking and grill roasting, which would make the whole cooking process easier and more efficient.

To address the above technical matters, the present invention incorporates technical solutions as follows:

A pellet oven with negative pressure combustion comprises: a grill body, a combustion assembly, an iron (or steel) plate, a grilling grate, an air duct assembly and a fan installed within said grill body. Said grilling grate is installed above said iron plate for a distance. Said combustion assembly is mounted in the lower left of said iron plate. Said air duct assembly is located at the right of said iron plate, and extends below said iron plate to a position under said grilling grate. Said air duct assembly has air inlet ports and air outlets at its lower and upper ends respectively. Said fan is installed inside said air duct assembly.

Preferably: said combustion assembly includes a hopper, a feeding channel, a motor, a firepot, an auger, an ash cleaner and an igniter. Said feeding channel is mounted at the bottom outlet of the hopper, where the inside of said hopper is connected with the inside of said feeding channel; said motor is mounted at one end of said feeding channel. Said auger is located within said feeding channel and connected with the output shaft of said motor; said firepot is installed at the outlet of said feeding channel, below the left end of said iron plate, and said ash cleaner is installed below said firepot; while said igniter is mounted on one side of said firepot.

Preferably: said firepot comes with a flame outlet at one end near said air duct assembly, and side walls of the bottom of which has several primary air inlet ports placed at regular intervals. Said flame outlet comes with secondary air inlet ports at its edge, which are also placed at regular intervals.

Preferably: a filter shield and a soot collection box are also included, which are both installed at the air inlet ports of said air duct assembly, and said filter shield is located inside said ash cleaner and said soot collection box has a top and/or side opening.

Preferably: said air duct assembly comes with several guiding vanes arranged from top to bottom at its air outlet.

Preferably: a grill lid is also included, which is mounted at the top opening of said grill body and connected through a rotation mechanism at one end with said grill body; and, said grill body has an observation window at the front.

Preferably: a drip container is also included, which is attached to the outlet of said iron plate and is detachable from said iron plate.

Preferably: a baking oven is also included, the top of which is set open. Said baking oven is mounted through a sliding mechanism into said grill body, to a position at a distance from the bottom of said iron plate and said combustion assembly is located above the left end of said baking oven.

Preferably: a temperature adjusting plate is also included, which is mounted through a rotation mechanism onto the inner wall of said baking oven and contains a protruding paddle. Said baking oven has a spacing slot and said paddle is inserted into said spacing slot. Said temperature adjustment plate comes with primary through-holes and said baking oven has secondary through-holes on one side. Said temperature adjusting plate can block the secondary through-holes. By turning said temperature adjusting plate, said primary through-holes can be thoroughly aligned with said secondary through-holes.

The benefits of the present invention lie in that: when materials are burning inside the combustion assembly, the fan activates and accelerates the airflow below the iron plate, creating a negative pressure zone under the iron plate that sucks in the heat and flame from the combustion assembly and the smell of burning wood pellets. The flame and heat are emitted laterally to fully heat the iron plate and cook the food on it. Furthermore, after entering the negative pressure zone, the heat and the smell of wood pellet combustion enters the air duct assembly through its air inlet ports, and then goes through the air duct assembly's air outlet to the space below the grilling grate, to grill/roast the food on the grilling grate in the same way as any conventional grill/roasting method. In this way, the present invention realizes simultaneous plate-cooking and grill roasting, making the whole cooking process easier and more efficient.

### BRIEF DESCRIPTION OF THE FIGURES

The present invention is further described below with accompanying drawings and an introduction to its specific implementation:

FIG. 1 is a cross-sectional view of an embodiment of the pellet oven with negative pressure combustion as described in the present invention;

FIG. 2 is a structural diagram of an embodiment of the pellet oven with negative pressure combustion as described in the present invention;

FIG. 3 is an internal structure diagram of an embodiment of the pellet oven with negative pressure combustion as described in the present invention;

FIG. 4 is another internal structure diagram of an embodiment of the pellet oven with negative pressure combustion as described in the present invention;

FIG. 5 is a structural diagram of the combustion assembly in the embodiment;

FIG. 6 is a structure diagram of the temperature adjusting plate in the embodiment;

FIG. 7 is a structure diagram of the iron plate and drip container in the embodiment;

FIG. 8 is a partial structure diagram of the baking oven and temperature adjusting plate in the embodiment.

Thereinto:
1. Grill body;
2. Iron plate;
3. Grilling grate;
4. Air duct assembly; 41. Guiding vanes;
5. Fan;
6. Hopper;
7. Feeding channel;
8. Motor;
9. Firepot; 91. Flame outlet; 92. Primary air inlet ports; 93. Secondary air inlet ports;
10. Auger;
11. Ash cleaner;
12. Igniter;
13. Filter shield;
14. Soot collection box;
15. Grill lid;
16. Drip container;
17. Baking oven; 171. Spacing slot; 172. Secondary through-holes;
18. Temperature adjusting plate; 181. Paddle; 182. Primary through-holes;
19. Observation window.

### DETAILED DESCRIPTION

To introduce the aim, technical features, and advantages of the present invention more clearly, it is further described below with accompanying drawings and an introduction to its specific implementation. It should be understood that the specific embodiments described herein are only for explaining the present invention and shall not be considered to limit the present invention.

It is understood that all position relationships described in the description of the present invention are based on the attached figures, the purpose of which is limited to explaining specific embodiments of the present invention and is not intended to express or imply that the components must be placed in a certain way. Therefore, such position relationships cannot be understood as a limitation of the present invention.

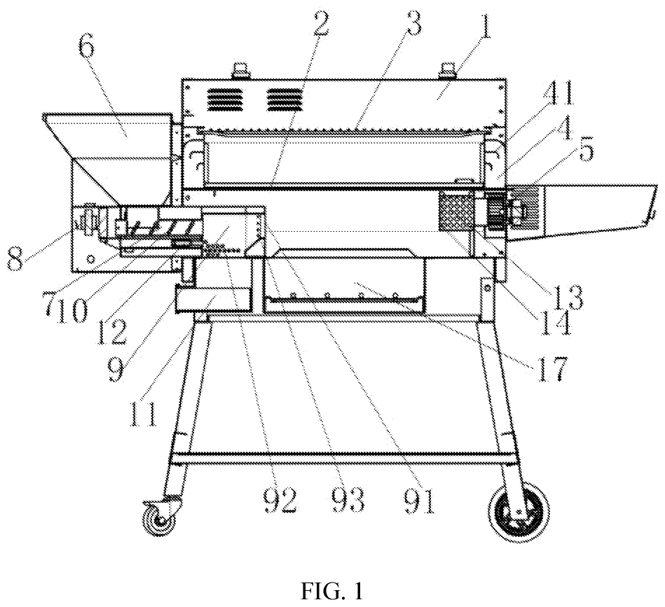

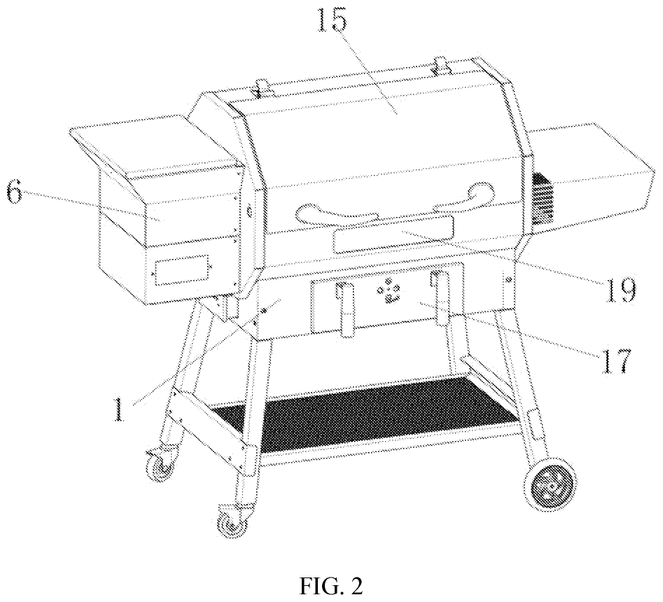

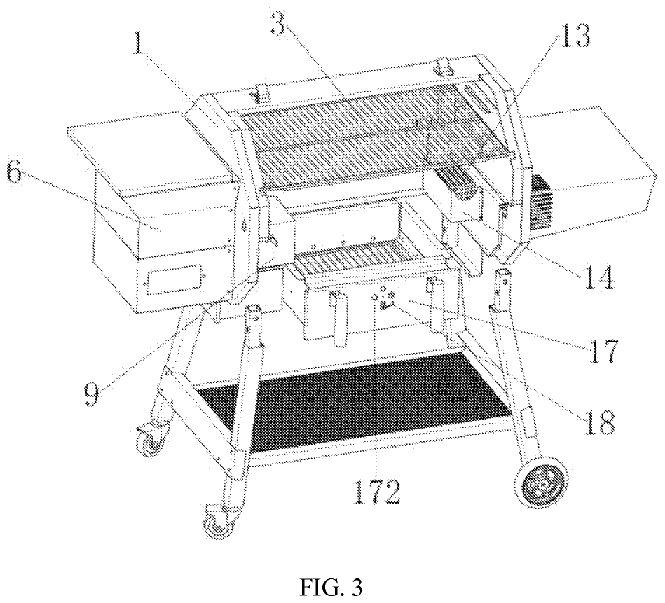

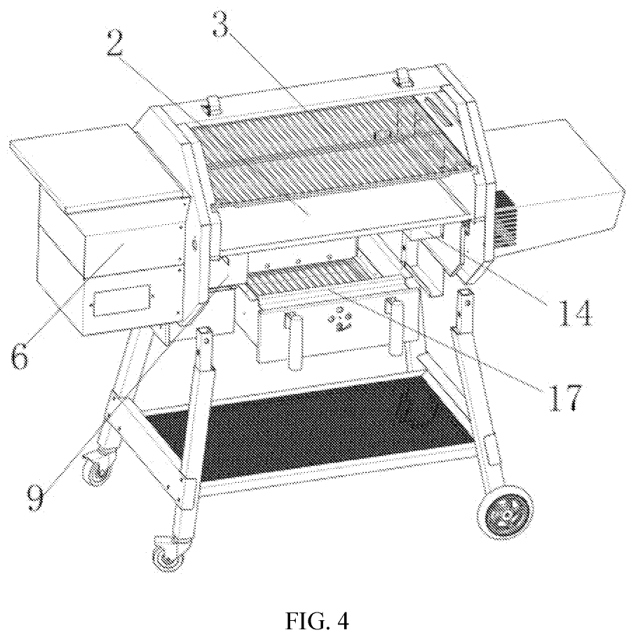

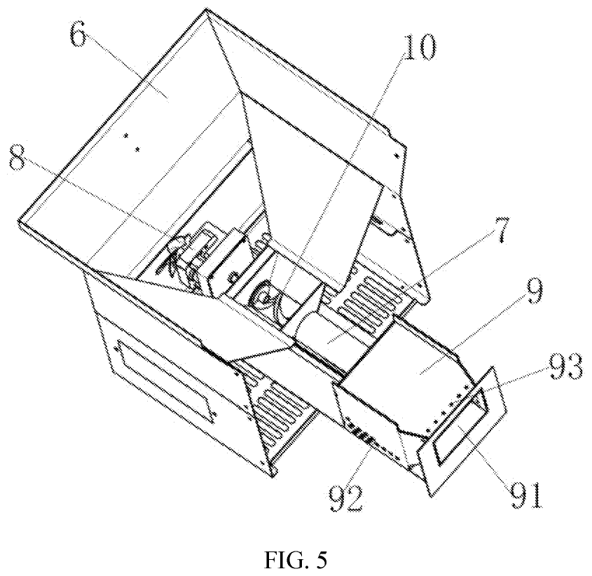

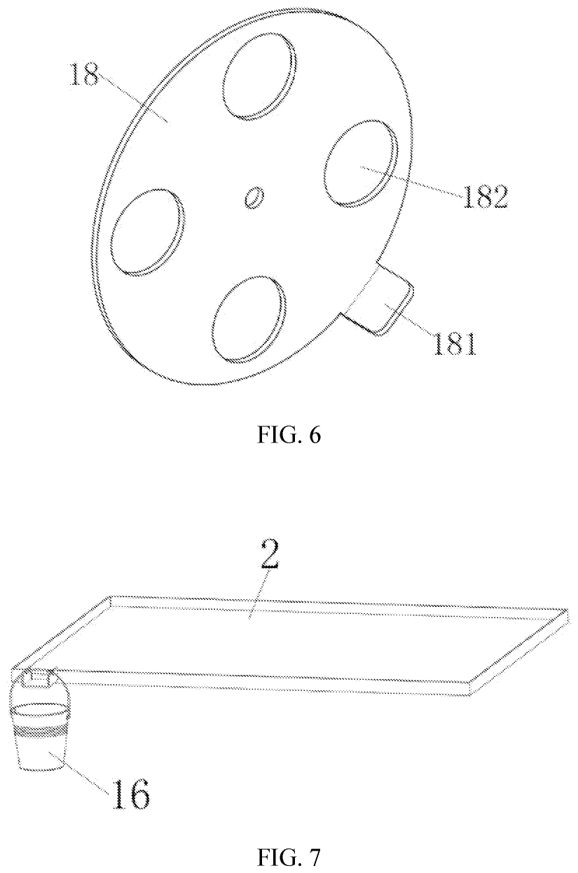

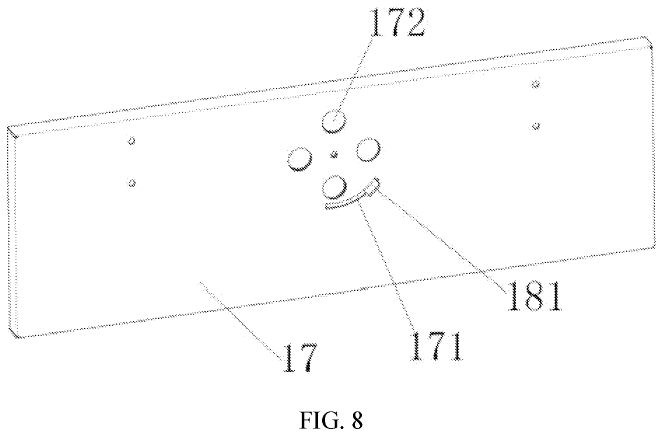

As shown in FIGS. 1 to 7, a pellet oven with negative pressure combustion, comprises: a grill body 1, and a combustion assembly, an iron plate 2, a grilling grate 3, an air duct assembly 4 and a fan 5 installed within said grill body 1. The grilling grate 3 is installed above the iron plate 2 for a distance. The combustion assembly is mounted in the lower left of the iron plate 2. The air duct assembly 4 is located at the right of the iron plate 2, and extends below the iron plate 2 to a position under the grilling grate 3. The air duct assembly 4 has air inlet ports and air outlets at its lower and upper ends respectively. The fan 5 is installed inside the air duct assembly 4.

In this way, when materials are burning inside the combustion assembly, fan 5 activates and accelerates the airflow below the iron plate 2, creating a negative pressure zone under the iron plate 2 that sucks in the heat and flame from the combustion assembly and the smell of burning wood pellets. The flame and heat are emitted laterally to fully heat the iron plate 2 and cook the food on it. Furthermore, after entering the negative pressure zone, the heat and the smell of wood pellet combustion enters the air duct assembly 4 through its air inlet ports, and then goes through the air duct assembly 4's air outlet to the space below the grilling grate 3, to grill-roast the food on the grilling grate 3 in the same way as any conventional grill-roasting method. In this way, the present invention realizes simultaneous plate-cooking and grill roasting, making the whole cooking process easier and more efficient.

In addition, the combustion assembly includes a hopper 6, a feeding channel 7, a motor 8, a firepot 9, an auger 10, an ash cleaner 11 and an igniter 12. The feeding channel 7 is mounted at the bottom outlet of hopper 6, where the inside of said hopper is connected with the inside of said feeding channel; the motor 8 is mounted at one end of the feeding channel 7. The auger 10 is located within the feeding channel 7 and connected with the output shaft of the motor 8; the firepot 9 is installed at the outlet of the feeding channel 7, below the left end of the iron plate 2, and the ash cleaner 11 is installed below the firepot 9; while the igniter 12 is mounted on one side of the firepot 9.

Through the aforesaid configuration, the rotation of motor 8 drives the rotation of auger 10 which gradually transports the wood pellets in hopper 6 into firepot 9, then igniter 12 ignites the wood pellets, and the carbon ash produced by the combustion of the wood pellets falls into the ash cleaner 11.

In addition, firepot 9 comes with a flame outlet 91 at one end near the air duct assembly 4, and side walls of the bottom of which has several primary air inlet ports 92 placed at regular intervals. The flame outlet 91 comes with secondary air inlet ports 93 at its edge, which are also placed at regular intervals.

Through the aforesaid configuration, fan 5 drives the flow of air, and a part of the air flows from the primary air inlet ports 92 into the bottom of the firepot 9 to promote the combustion of wood pellets, the other part of the air flows from the secondary air inlet ports 93 into the firepot 9, mixes with the hot flue gas and dust (from primary combustion) for a secondary combustion. It not only reduces flue gas and dust emissions and improves cleanliness, but also improves combustion efficiency and fuel utilization.

In addition, a filter shield 13 and soot collection box 14 are also included, which are both installed at the air inlet ports of the air duct assembly 4, and the filter shield 13 is located inside the ash cleaner 11 and the soot collection box 14 has a top opening.

Through the aforesaid configuration, the solid dust produced by the combustion of wood pellets is carried by the flowing air under the action of fan 5 and then filtered out by filter shield 13, making the food more clean and hygienic.

In addition, the air duct assembly 4 comes with several guiding vanes 41 arranged from top to bottom at its air outlet.

Through the aforesaid configuration, guiding vanes 41 can divert the airflow from the air outlet of air duct assembly 4, so that heat in the airflow is more evenly distributed to all parts of grilling grate 3, allowing for more uniform heating, more accurate temperature control and in turn higher roasting quality.

In addition, a grill lid 15 is also included, which is mounted at the top opening of the grill body 1, and connected through a rotation mechanism at one end with the grill body 1; And the grill body 1 has an observation window 19 at the front.

Through the aforesaid configuration, grill lid 15 can be used to control the opening and closing of grill body 1, thereby controlling the temperature therein. And observation window 19 allows for observing the combustion conditions in grill body 1 and enjoying the sight of a dancing flame.

In addition, a drip container 16 is also included, which is attached to the oil outlet of the iron plate 2, and is detachable from the iron plate 2.

Through the aforesaid configuration, oil from iron plate 2 can flow into drip container 16 through the oil outlet.

In addition, a baking oven 17 is also included, the top of which is set open. The baking oven 17 is mounted through a sliding mechanism into the grill body 1, to a position at a distance from the bottom of the iron plate 2 and the combustion assembly is located above the left end of the baking oven 17.

Through the aforesaid configuration, temperature of the baking oven 17 located below iron plate 2 will be cooler than those of iron plate 2 and grilling grate 3, and therefore the baking oven 17 can be used to cook some food that requires long-time heating or to keep food warm. In this way, the heat in the lower part of grill body 1 is recycled, and the heat loss in grill body 1 is prevented, helping to increase the temperature in grill body 1.

In addition, a temperature adjusting plate 18 is also included, which is mounted through a rotation mechanism onto the inner wall of the baking oven 17 and contains a protruding paddle 181. The baking oven 17 has a spacing slot 171 and the paddle 181 is inserted into the spacing slot 171. The temperature adjustment plate 18 comes with primary through-holes 182 and the baking oven 17 has secondary through-holes 172 on one side. The temperature adjusting plate 18 can block the secondary through-holes 172. By turning the temperature adjusting plate 18, the primary through-holes 182 can be thoroughly aligned with the secondary through-holes 172.

Through the aforesaid configuration, when the primary through-holes 182 and secondary through-holes 172 on the temperature adjusting plate 18 are aligned by turning the temperature adjusting plate 18, the heat inside the baking oven 17 exits out of the secondary through-holes 172; when the temperature adjusting plate 18 blocks secondary through-holes 172, the heat in oven 17 cannot get out from secondary through-holes 172. In this way, the temperature in baking oven 17 can be controlled.

In summary, the foregoing represents only a preferred embodiment of the present invention and shall not be considered to limit the present invention. Any modifications, equivalent substitutions and improvements made in a manner consistent with the spirit and scope of the invention herein shall also be covered by the protection thereof.

1. A pellet oven with negative pressure combustion, characterized in that: comprising: a grill body, and a combustion assembly, an iron plate, a grilling grate, an air duct assembly and a fan installed within said grill body; wherein, said grilling grate is installed above said iron plate for a distance; said combustion assembly is mounted in the lower left of said iron plate; said air duct assembly is located at the right of said iron plate, and extends below said iron plate to a position under said grilling grate; said air duct assembly has air inlet ports and air outlets at its lower and upper ends respectively; and said fan is installed inside said air duct assembly.

2. The pellet oven with negative pressure combustion according to claim 1, characterized in that: said combustion assembly includes a hopper, a feeding channel, a motor, a firepot, an auger, an ash cleaner and an igniter; wherein said feeding channel is mounted at the bottom outlet of the hopper, where the inside of said hopper is connected with the inside of said feeding channel; said motor is mounted at one end of said feeding channel; said auger is located within said feeding channel and connected with the output shaft of said motor; said firepot is installed at the outlet of said feeding channel, below the left end of said iron plate, and said ash cleaner is installed below said firepot; while said igniter is mounted on one side of said firepot.

3. The pellet oven with negative pressure combustion according to claim 2, characterized in that: said firepot is provided with a flame outlet at one end near said air duct assembly, and side walls of the bottom of which has several primary air inlet ports placed at regular intervals; said flame outlet is provided with secondary air inlet ports at its edge, which are also placed at regular intervals.

4. The pellet oven with negative pressure combustion according to claim 2, characterized in that: the pellet oven further comprises a filter shield and a soot collection box, which are both installed at the air inlet ports of said air duct assembly, and said filter shield is located inside said ash cleaner and said soot collection box has a top opening.

5. The pellet oven with negative pressure combustion according to claim 4, characterized in that: said air duct assembly is provided with several guiding vanes arranged from top to bottom at its air outlet.

6. The pellet oven with negative pressure combustion according to claim 5, characterized in that: the pellet oven further comprises a grill lid, which is mounted at the top opening of said grill body, and connected through a rotation mechanism at one end with said grill body; and said grill body has an observation window at the front.

7. The pellet oven with negative pressure combustion according to claim 6, characterized in that: the pellet oven further comprises a drip container, which is attached to the oil outlet of said iron plate, and is detachable from said iron plate.

8. The pellet oven with negative pressure combustion according to claim 1, characterized in that: the pellet oven further comprises a baking oven, the top of which is set open; said baking oven is mounted through a sliding mechanism into said grill body, to a position at a distance from the bottom of said iron plate and said combustion assembly is located above the left end of said baking oven.

9. The pellet oven with negative pressure combustion according to claim 8, is characterized in that: the pellet oven further comprises a temperature adjusting plate, which is mounted through a rotation mechanism onto the inner wall of said baking oven and contains a protruding paddle; said baking oven has a spacing slot and said paddle is inserted into said spacing slot; said temperature adjustment plate is provided with primary through-holes and said baking oven has secondary through-holes on one side; said temperature adjusting plate can block said secondary through holes; by turning said temperature adjusting plate, said primary through-holes can be thoroughly aligned with said secondary through-holes.

10. The pellet oven with negative pressure combustion according to claim 2, characterized in that: the pellet oven further comprises a baking oven, the top of which is set open; said baking oven is mounted through a sliding mechanism into said grill body, to a position at a distance from the bottom of said iron plate and said combustion assembly is located above the left end of said baking oven.

11. The pellet oven with negative pressure combustion according to claim 10, is characterized in that: the pellet oven further comprises a temperature adjusting plate, which is mounted through a rotation mechanism onto the inner wall of said baking oven and contains a protruding paddle; said baking oven has a spacing slot and said paddle is inserted into said spacing slot; said temperature adjustment plate is provided with primary through-holes and said baking oven has secondary through-holes on one side; said temperature adjusting plate can block said secondary through holes; by turning said temperature adjusting plate, said primary through-holes can be thoroughly aligned with said secondary through-holes.

12. The pellet oven with negative pressure combustion according to claim 3, characterized in that: the pellet oven further comprises a baking oven, the top of which is set open; said baking oven is mounted through a sliding mechanism into said grill body, to a position at a distance from the bottom of said iron plate and said combustion assembly is located above the left end of said baking oven.

13. The pellet oven with negative pressure combustion according to claim 12, is characterized in that: the pellet oven further comprises a temperature adjusting plate, which is mounted through a rotation mechanism onto the inner wall of said baking oven and contains a protruding paddle; said baking oven has a spacing slot and said paddle is inserted into said spacing slot; said temperature adjustment plate is provided with primary through-holes and said baking oven has secondary through-holes on one side; said temperature adjusting plate can block said secondary through holes; by turning said temperature adjusting plate, said primary through-holes can be thoroughly aligned with said secondary through-holes.

14. The pellet oven with negative pressure combustion according to claim 4, characterized in that: the pellet oven further comprises a baking oven, the top of which is set open; said baking oven is mounted through a sliding mechanism into said grill body, to a position at a distance from the bottom of said iron plate and said combustion assembly is located above the left end of said baking oven.

15. The pellet oven with negative pressure combustion according to claim 14, is characterized in that: the pellet oven further comprises a temperature adjusting plate, which is mounted through a rotation mechanism onto the inner wall of said baking oven and contains a protruding paddle; said baking oven has a spacing slot and said paddle is inserted into said spacing slot; said temperature adjustment plate is provided with primary through-holes and said baking oven has secondary through-holes on one side; said temperature adjusting plate can block said secondary through holes; by turning said temperature adjusting plate, said primary through-holes can be thoroughly aligned with said secondary through-holes.

16. The pellet oven with negative pressure combustion according to claim 5, characterized in that: the pellet oven further comprises a baking oven, the top of which is set open; said baking oven is mounted through a sliding mechanism into said grill body, to a position at a distance from the bottom of said iron plate and said combustion assembly is located above the left end of said baking oven.

17. The pellet oven with negative pressure combustion according to claim 16, is characterized in that: the pellet oven further comprises a temperature adjusting plate, which is mounted through a rotation mechanism onto the inner wall of said baking oven and contains a protruding paddle; said baking oven has a spacing slot and said paddle is inserted into said spacing slot; said temperature adjustment plate is provided with primary through-holes and said baking oven has secondary through-holes on one side; said temperature adjusting plate can block said secondary through holes; by turning said temperature adjusting plate, said primary through-holes can be thoroughly aligned with said secondary through-holes.

18. The pellet oven with negative pressure combustion according to claim 6, characterized in that: the pellet oven further comprises a baking oven, the top of which is set open; said baking oven is mounted through a sliding mechanism into said grill body, to a position at a distance from the bottom of said iron plate and said combustion assembly is located above the left end of said baking oven.

19. The pellet oven with negative pressure combustion according to claim 18, is characterized in that: the pellet oven further comprises a temperature adjusting plate, which is mounted through a rotation mechanism onto the inner wall of said baking oven and contains a protruding paddle; said baking oven has a spacing slot and said paddle is inserted into said spacing slot; said temperature adjustment plate is provided with primary through-holes and said baking oven has secondary through-holes on one side; said temperature adjusting plate can block said secondary through holes; by turning said temperature adjusting plate, said primary through-holes can be thoroughly aligned with said secondary through-holes.

20. The pellet oven with negative pressure combustion according to claim 7, characterized in that: the pellet oven further comprises a baking oven, the top of which is set open; said baking oven is mounted through a sliding mechanism into said grill body, to a position at a distance from the bottom of said iron plate and said combustion assembly is located above the left end of said baking oven.

21. The pellet oven with negative pressure combustion according to claim 20, is characterized in that: the pellet oven further comprises a temperature adjusting plate, which is mounted through a rotation mechanism onto the inner wall of said baking oven and contains a protruding paddle; said baking oven has a spacing slot and said paddle is inserted into said spacing slot; said temperature adjustment plate is provided with primary through-holes and said baking oven has secondary through-holes on one side; said temperature adjusting plate can block said secondary through holes; by turning said temperature adjusting plate, said primary through-holes can be thoroughly aligned with said secondary through-holes.
